(19) United States
(12) Patent Application Publication
(10) Pub. No.: US 2026/0316794 A1
(43) Pub. Date: Oct. 15, 2026

(54) VEHICLE CONTROL SYSTEM

(71) Applicant: TOYOTA JIDOSHA KABUSHIKI KAISHA, Toyota-shi Aichi-ken (JP)

(72) Inventors: Daichi HOTTA, Meguro-ku Tokyo-to (JP); Taichi KAWANAI, Shizuoka-shi Shizuoka-ken (JP); Yusuke HAYASHI, Atsugi-shi Kanagawa-ken (JP); Sadayuki ABE, Sunto-gun Shizuoka-ken (JP)

(73) Assignee: TOYOTA JIDOSHA KABUSHIKI KAISHA, Toyota-shi Aichi-ken (JP)

(21) Appl. No.: 19/642,008

(22) Filed: Apr. 8, 2026

(30) Foreign Application Priority Data
Apr. 11, 2025 (JP) 2025-065595

(51) Int. Cl. B60W 60/00; B60W 50/02; B60W 50/023

(52) U.S. Cl. CPC B60W 60/0059; B60W 50/0205; B60W 50/023; B60W 60/001; B60W 2420/403

(57) ABSTRACT

A vehicle control system for controlling a vehicle as processing circuitry configured to execute automated driving control by switching between a plurality of automated driving levels. The plurality of automated driving levels include: a first level that requires a human operation or human monitoring as needed; and a second level that does not require a driving operation by a human. During execution of the automated driving control, the processing circuitry acquires abnormality detection information indicating detection of an abnormality of a component of the vehicle used for the automated driving control. Then, the processing circuitry determines a response of the automated driving control to the abnormality, based on both a content of the abnormality and a current automated driving level.

### CROSS-REFERENCES TO RELATED APPLICATION

The present disclosure claims priority to Japanese Patent Application No. 2025-065595, filed on Apr. 11, 2025, the contents of which application are incorporated herein by reference in their entirety.

### TECHNICAL FIELD

The present disclosure relates to a vehicle that executes automated driving control by switching between a plurality of automated driving levels.

### BACKGROUND ART

Patent Literature 1 discloses an automated driving control device mounted on a vehicle. Driving modes of the vehicle include an advanced automated mode and a basic mode. In the advanced automated mode, the automated driving control device performs a predetermined automated driving operation. When a predetermined release event occurs during execution of the advanced automated mode, the automated driving control device stops at least one of the automated driving operations being executed.

### List of Related Art

Patent Literature 1: Japanese Patent Application Publication No. 2024-045477

### SUMMARY

Conventionally, it has been proposed to terminate automated driving control when an abnormality occurs in a vehicle executing the automated driving control (see Patent Literature 1). However, there are various automated driving levels. Terminating the automated driving control uniformly regardless of the automated driving level is not necessarily desirable from a viewpoint of continuity of the operation of the vehicle. In addition, there may be a variety of contents of the abnormality in the vehicle. Terminating the automated driving control uniformly regardless of the content of the abnormality is not necessarily desirable from a viewpoint of continuity of the operation of the vehicle.

An aspect of the present disclosure relates to a vehicle control system for controlling a vehicle.

The vehicle control system has one or more processors configured to execute automated driving control by switching between a plurality of automated driving levels.

The plurality of automated driving levels include: a first level that requires a human operation or human monitoring as needed; and a second level that does not require a driving operation by a human.

During execution of the automated driving control, the one or more processors acquire abnormality detection information indicating detection of an abnormality of a component of the vehicle used for the automated driving control. Then, the one or more processors determine a response of the automated driving control to the abnormality, based on both a content of the abnormality and a current automated driving level.

According to the present disclosure, even when an abnormality of a component used for the automated driving control is detected, the automated driving control is not uniformly terminated. When an abnormality of a component used for the automated driving control is detected, a response of the automated driving control to the abnormality is determined based on both the content of the abnormality and the current automated driving level. Considering both the content of the abnormality and the current automated driving level makes it possible to appropriately determine the response of the automated driving control to the abnormality. Furthermore, since the automated driving control is not uniformly terminated, it is possible to suppress a decrease in continuity of the operation of the vehicle.

### BRIEF DESCRIPTION OF DRAWINGS

FIG. 1 is a block diagram showing an example of a configuration of a vehicle control system;

FIG. 2 is a conceptual diagram for explaining an example of a plurality of operation modes;

FIG. 3 is a block diagram showing an example of a functional configuration related to determination of an automated driving control state;

FIG. 4 is a conceptual diagram for explaining an example of a control state determination unit;

FIG. 5 is a diagram showing various examples of setting of the automated driving control state; and

FIG. 6 is a flowchart showing processing related to the determination of the automated driving control state.

### DETAILED DESCRIPTION

### 1. Vehicle control system

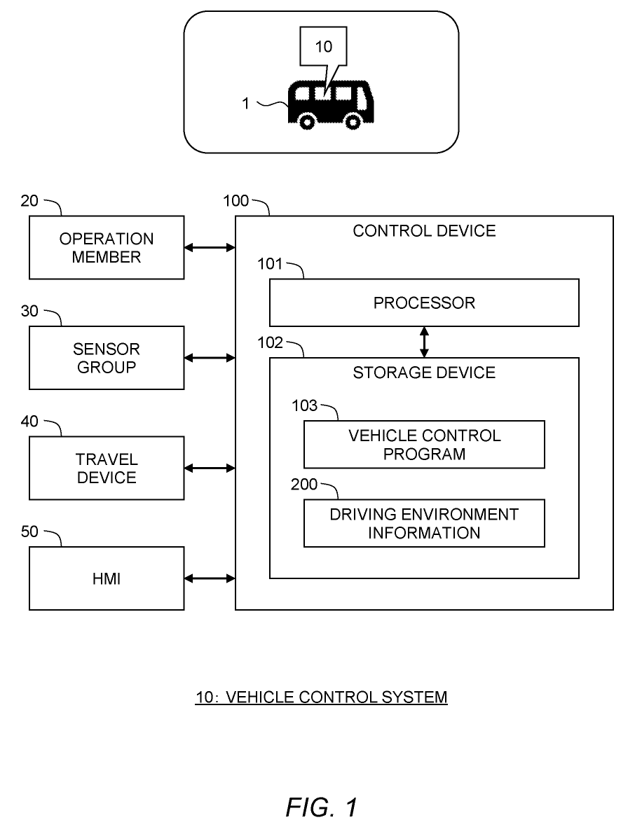

FIG. 1 is a conceptual diagram for explaining an overview of a vehicle control system 10 according to the present embodiment. The vehicle control system 10 controls a vehicle 1. Typically, the vehicle control system 10 is mounted on the vehicle 1. Alternatively, the vehicle control system 10 may be distributed to the vehicle 1 and an external device. The vehicle control system 10 includes an operation member 20, a sensor group 30, a travel device 40, a human machine interface (HMI) 50, and a control device 100.

The operation member 20 is a member that can be operated by an operator of the vehicle 1. The operator may be a driver who is on board the vehicle 1, or may be a remote operator (remote driver) who remotely operates the vehicle 1. When the operator is on board the vehicle 1, the operation member 20 is mounted on the vehicle 1. When the operator is a remote operator, the operation member 20 is provided in a remote operator terminal. The operation member 20 is used for manual driving by the operator. In addition, the operation member 20 is used when the operator intervenes in the automated driving. Examples of the operation member 20 include a steering wheel, an accelerator pedal, a brake pedal, a joystick, a button, a switch, a lever, and the like.

The sensor group 30 includes an operation sensor for detecting an operation state (e.g., an operation amount and an operation speed) of the operation member 20. An operation amount (a steering angle, a steering torque) of the steering wheel is detected by a steering angle sensor and a steering torque sensor. An operation amount (a stroke amount) of the accelerator pedal is detected by an accelerator position sensor. An operation amount (a stroke amount) of the brake pedal is detected by a brake pedal sensor. The operation speed is calculated from a temporal change in the operation amount.

The sensor group 30 further includes a recognition sensor, a vehicle state sensor, a position sensor, and the like mounted on the vehicle 1. The recognition sensor recognizes (detects) a situation around the vehicle 1. Examples of the recognition sensor include a camera, a LIDAR, a radar, and the like. The vehicle state sensor detects a state of the vehicle 1. The vehicle state sensor includes a speed sensor, an acceleration sensor, a yaw rate sensor, a steering angle sensor, and the like. The position sensor detects a position and an orientation of the vehicle 1. For example, the position sensor includes a global navigation satellite system (GNSS).

It should be noted that at least a part of the sensors in the sensor group 30 may have a redundant configuration. That is, at least a part of the sensors may include a main system and a sub system.

The travel device 40 includes a steering device, a driving device, and a braking device (brake). The steering device turns the wheels. For example, the steering device includes a power steering device. The drive device is a power source that generates a driving force. Examples of the drive device include an engine, an electric motor, an in-wheel motor, and the like. The braking device generates a braking force.

It should be noted that at least a part of the travel device 40 may have a redundant configuration. That is, at least a part of the travel device 40 may include a main system and a sub system. For example, the braking device (brake) may have a redundant configuration.

The HMI 50 is a user interface for receiving information from the operator in the vehicle 1 and providing information to the operator. The HMI 50 includes an input device and an output device. Examples of the input device include a touch panel, a keyboard, a button, a microphone, and the like. Examples of the output device include a display device, a touch panel, a speaker, and the like. Examples of the display device include a display, a head-up display, and the like.

The control device 100 is a computer that controls the vehicle 1. The control device 100 includes one or more processors 101 and one or more storage devices 102. The processor 101 executes a variety of processing. For example, the processor 101 includes a central processing unit (CPU). The processor 101 may also be referred to as processing circuitry. The storage device 102 stores a variety of information. Examples of the storage device 102 include a volatile memory, a nonvolatile memory, a hard disk drive (HDD), a solid state drive (SSD), and the like.

A vehicle control program 103 is a computer program for controlling the vehicle 1. The function of the control device 100 may be realized by a cooperation of the processor 101 executing the vehicle control program 103 and the storage device 102. The vehicle control program 103 is stored in the storage device 102. Alternatively, the vehicle control program 103 may be recorded in a non-transitory computer-readable recording medium.

The control device 100 acquires driving environment information 200 indicating a driving environment for the vehicle 1. The driving environment information 200 is stored in the storage device 102. The driving environment information 200 includes map information, surrounding situation information, vehicle state information, vehicle position information, and the like.

The map information includes a general navigation map. The map information may indicate a lane arrangement and a road shape.

The surrounding situation information, which is obtained based on the recognition sensor, indicates a situation around the vehicle 1. For example, the surrounding situation information includes an image captured by the camera. As another example, the surrounding situation information may include point group information obtained by the LIDAR. The surrounding situation information may include object information on an object around the vehicle 1. Examples of the object around the vehicle 1 include a pedestrian, another vehicle (a preceding vehicle, a vehicle, or the like), a white line, a traffic signal, a sign, a roadside structure, and the like. The object information indicates a relative position and a relative speed of the object with respect to the vehicle 1.

The vehicle state information, which is detected by the vehicle state sensor, indicates a traveling state of the vehicle 1. Examples of the traveling state include a vehicle speed, a steering angle, an acceleration, a yaw rate, and the like.

The vehicle position information, which is detected by the position sensor, indicates the position and the orientation of the vehicle 1.

Moreover, the control device 100 executes vehicle travel control that controls the travel of the vehicle 1. The vehicle travel control includes steering control, acceleration control, and deceleration control. The control device 100 executes the vehicle travel control by controlling the travel device 40 (i.e., the steering device, the driving device, and the braking device).

Furthermore, the control device 100 performs an automated driving control that controls the automated driving of the vehicle 1. Here, the automated driving means that at least one of steering, acceleration, and deceleration of the vehicle 1 is automatically performed independently of an operation performed by a driver. For example, the control device 100 generates a travel plan of the vehicle 1 based on the driving environment information 200. Examples of the travel plan include maintaining the current travel lane, changing lanes, turning right or left, avoiding an obstacle, and the like. Further, the control device 100 generates a target trajectory necessary for the vehicle 1 to travel according to the travel plan based on the driving environment information 200. Then, the control device 100 performs the vehicle travel control such that the vehicle 1 follows the target trajectory.

### 2. Multiple levels of automated driving / driving modes

The vehicle control system 10 (the control device 100) according to the present embodiment is configured to be able to perform the automated driving control by switching between a plurality of automated driving levels. The plurality of automated driving levels include at least a first level and a second level.

The first level requires a human (operator) operation as needed. For example, when it is difficult to continue the automated driving, the vehicle control system 10 issues a transition demand to request a human to start a driving operation. The first level may request a human to monitor the surroundings of the vehicle 1 as needed. It can be said that the first level is an automated driving level equal to or lower than so-called Level 3.

On the other hand, the second level does not require a driving operation by a human (operator). At the second level, the vehicle control system 10 performs all dynamic driving tasks. Even when it is difficult to continue the automated driving, the vehicle control system 10 performs safety control by itself without requiring intervention from a human. It can be said that the second level is an automated driving level of so-called Level 4 or higher.

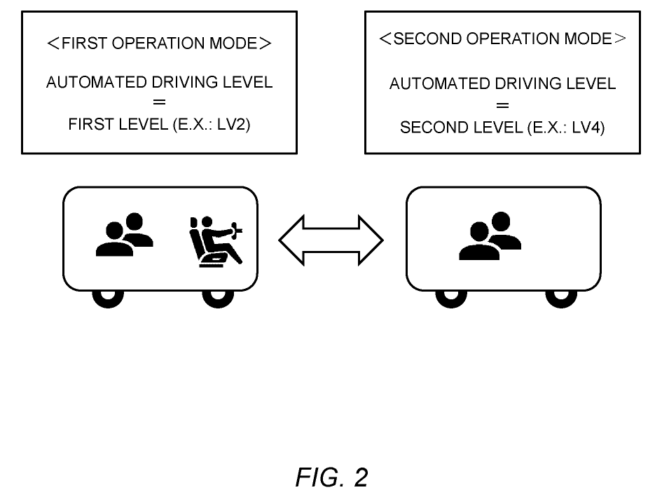

FIG. 2 is a conceptual diagram for explaining an example of a plurality of operation modes based on a plurality of automated driving levels. In a first operation mode, the automated driving control of the first level (for example, Level 2) is performed. Therefore, in the first operation mode, there is a safety driver who takes over the driving operation as necessary or a safety monitoring operator who performs monitoring as necessary. On the other hand, in a second operation mode, the automated driving control of the second level (for example, Level 4) is performed. In the second operation mode, there is no safety driver or safety monitoring operator.

A user or an administrator of the vehicle 1 can select a desired operation mode (i.e., automated driving level). For example, the user or the administrator of the vehicle 1 designates a desired operation mode (i.e., automated driving level) through the HMI 50 of the vehicle control system 10.

The user or the administrator of the vehicle 1 may switch the operation mode (i.e., automated driving level) depending on a location or a time. As an example, an operation of an automated driving bus service is considered. For example, the first operation mode is selected on a public road, and the vehicle 1 travels with a safety driver and passengers on board. As another example, the second operation mode is selected in a closed section, and the vehicle 1 travels with only passengers on board.

It should be noted that in the second operation mode, the operation member 20 may be detached from the vehicle 1, since the operation member 20 is never used by the safety driver. That is, the operation member 20 may be detachable. For example, in software verification in a development stage, the operation member 20 is attached to the vehicle 1, and the software verification is performed in the first operation mode. In a service providing stage, the operation member 20 may be detached from the vehicle 1, and the service may be provided in the second operation mode.

Whereas, in the state where the operation member 20 is detached from the vehicle 1, the safety driver cannot take over the driving operation. Therefore, in the state where the operation member 20 is detached from the vehicle 1, the first operation mode cannot be selected. The first operation mode is selectable only in a state where the operation member 20 is attached to the vehicle 1.

The operation mode is basically selected at a timing of transition from manual driving to automated driving. It may be possible to switch the operation mode from the first operation mode to the second operation mode when the vehicle 1 is traveling in the first operation mode. However, it is not permitted to switch the operation mode from the second operation mode to the first operation mode during traveling.

### 3. Change of Automated Driving Control State

During execution of the automated driving control, it may be necessary to consider whether to change a state of the automated driving control. Examples of the state of the automated driving control include a normal state, a fail degraded state, a fail operational state, a fail safe state, a fail silent state, and the like.

For example, in embodiments, when an abnormality of a component (for example, the sensor group 30, the travel device 40) of the vehicle 1 used for the automated driving control is detected, it is considered whether to change the state of the automated driving control. As another example, in embodiments, when the operator operates the operation member 20 to intervene in the automated driving, it is considered whether to change the state of the automated driving control. Such the abnormality detection or the intervention operation performed by the operator is hereinafter referred to as a "trigger".

During execution of the automated driving control, it is desirable to consider whether to change the state of the automated driving control in response to the trigger. For example, it is conceivable to terminate the automated driving control in response to the trigger. However, as described above, there are various automated driving levels. Terminating the automated driving control uniformly regardless of the automated driving level is not necessarily desirable from a viewpoint of continuity of the operation of the vehicle. In addition, there may be a variety of contents of the abnormality. Terminating the automated driving control uniformly regardless of the content of the abnormality is not necessarily desirable from a viewpoint of continuity of the operation of the vehicle.

In view of the above, the vehicle control system 10 (the control device 100) according to the present embodiment is configured to be able to appropriately set the state of the automated driving control according to the situation. More specifically, when the vehicle control system 10 receives the trigger during execution of the automated driving control, the vehicle control system 10 determines an appropriate state of the automated driving control in consideration of both the content of the trigger and the current automated driving level. That is, the vehicle control system 10 determines a response of the automated driving control to the trigger, based on both the content of the trigger and the current automated driving level. Since the automated driving control is not uniformly terminated, it is possible to suppress a decrease in continuity of the operation of the vehicle 1.

In particular, the case where the trigger is the abnormality detection is as follows. During execution of the automated driving control, the vehicle control system 10 (the control device 100) acquires abnormality detection information indicating detection of an abnormality of a component (for example, the sensor group 30 or the travel device 40) of the vehicle 1 used for the automated driving control. When the abnormality detection information is acquired, the vehicle control system 10 determines an appropriate state of the automated driving control in consideration of both the content of the abnormality indicated by the abnormality detection information and the current automated driving level. That is, the vehicle control system 10 determines a response of the automated driving control to the abnormality, based on both the content of the abnormality and the current automated driving level.

As described above, according to the present embodiment, even when an abnormality of a component used for the automated driving control is detected, the automated driving control is not uniformly terminated. When an abnormality of a component used for the automated driving control is detected, a response of the automated driving control to the abnormality is determined based on both the content of the abnormality and the current automated driving level. Considering both the content of the abnormality and the current automated driving level makes it possible to appropriately determine the response of the automated driving control to the abnormality. Furthermore, since the automated driving control is not uniformly terminated, it is possible to suppress a decrease in continuity of the operation of the vehicle.

### 4. Concrete examples of determination of automated driving control state

### 4-1. Functional Configuration Example

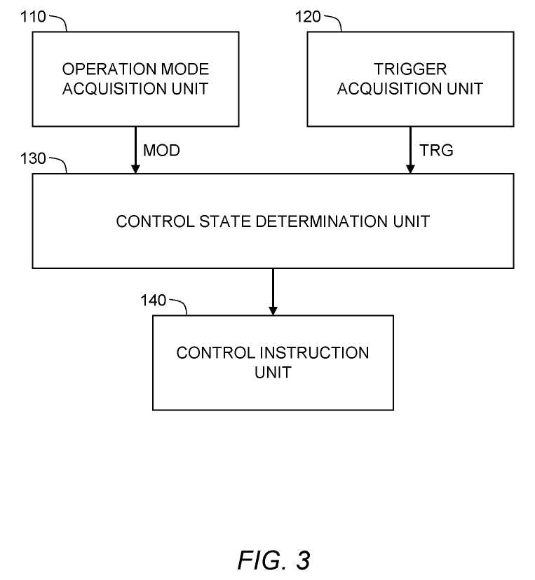

FIG. 3 is a block diagram illustrating an example of a functional configuration related to determination of the automated driving control state. The control device 100 of the vehicle control system 10 includes, as functional blocks, an operation mode acquisition unit 110, a trigger acquisition unit 120, a control state determination unit 130, and a control instruction unit 140. These functional blocks may be realized by a cooperation between the processor 101 executing the vehicle control program 103 and the storage device 102.

The operation mode acquisition unit 110 acquires operation mode information MOD indicating the current operation mode. For example, the user or the administrator of the vehicle 1 designates a desired operation mode (automated driving level) through the HMI 50. The operation mode acquiring unit 110 acquires the operation mode information MOD from the HMI 50. In the present embodiment, the "operation mode" and the "automated driving level" are equivalent to each other. That is, the "first operation mode" and the "first level" are equivalent to each other, and the "second operation mode" and the "second level" are equivalent to each other. The operation mode acquisition unit 110 can also be said to acquire information indicating the current automated driving level.

During execution of the automated driving control, the trigger acquisition unit 120 acquires trigger information TRG indicating the trigger for determining the automated driving control state.

A first example of the trigger is detection of an abnormality (failure) of a sensor included in the sensor group 30 used for the automated driving control. For example, the trigger is that an abnormality of the recognition sensor is detected. Examples of the recognition sensor include a camera, a LIDAR, a radar, and the like. In a case where the sensor has a redundant configuration, an abnormality in one of the main system and the sub system also serves as the trigger. For example, the trigger acquisition unit 120 can detect the abnormality of the sensor by detecting an abnormality (for example, fixation) of data output from the sensor. The data output from the sensor is obtained from the driving environment information 200. As another example, the sensor itself may have a self-diagnosis function. In this case, the trigger acquisition unit 120 can detect the abnormality of the sensor based on the self-diagnosis result of the sensor. When the trigger acquisition unit 120 detects the abnormality of the sensor, the trigger acquisition unit 120 acquires abnormality detection information indicating the detection of the abnormality of the sensor as the trigger information TRG.

A second example of the trigger is detection of an abnormality (failure) of at least a part of the travel device 40 used for the automated driving control. The travel device 40 includes the steering device, the driving device, and the braking device (brake). For example, the trigger is detection of an abnormality of the brake. When the device has a redundant configuration, an abnormality of one of the main system and the sub system also serves as the trigger. For example, the trigger acquisition unit 120 can determine whether or not an abnormality has occurred in the device by comparing a control instruction to the device with a response of the device. As another example, the device itself may have a self-diagnosis function. In this case, the trigger acquisition unit 120 can detect the abnormality of the device based on the self-diagnosis result of the device. When the trigger acquisition unit 120 detects the abnormality of the device, the trigger acquisition unit 120 acquires abnormality detection information indicating the detection of the abnormality of the device as the trigger information TRG.

A third example of the trigger is that the operator operates the operation member 20 to intervene in the automated driving. As described above, the sensor group 30 includes the operation sensor for detecting the operation state (the operation amount and the operation speed) of the operation member 20. The trigger acquisition unit 120 can detect an intervention operation by the operator based on a result of detection by the operation sensor. For example, when the operation amount of the steering wheel exceeds a first threshold value, this is detected as an intervention operation. As another example, when a state in which the operation amount of the steering wheel exceeds the first threshold value continues for a first time or more, this is detected as the intervention operation. As still another example, when the operation amount of the brake pedal exceeds a second threshold value, this is detected as the intervention operation. As still another example, when a state in which the operation amount of the brake pedal exceeds the second threshold value continues for a second time or more, this is detected as the intervention operation. When the trigger acquisition unit 120 detects the intervention operation by the operator, the trigger acquisition unit 120 acquires intervention detection information indicating the detection of the intervention operation as the trigger information TRG.

During the execution of the automated driving control, the control state determination unit 130 appropriately determines the automated driving control state based on the operation mode information MOD and the trigger information TRG. That is, the control state determination unit 130 appropriately determines the automated driving control state based on the current operation mode (i.e., the current automated driving level) and the content of the trigger. In other words, the control state determination unit 130 determines a response of the automated driving control to the trigger, based on the current operation mode (i.e, the current automated driving level) and the content of the trigger.

The control instruction unit 140 determines a control instruction amount of the travel device 40 according to the automated driving control state determined by the control state determination unit 130, and controls the travel device 40. That is, the control instruction unit 140 controls the travel of the vehicle 1 according to the automated driving control state determined by the control state determination unit 130.

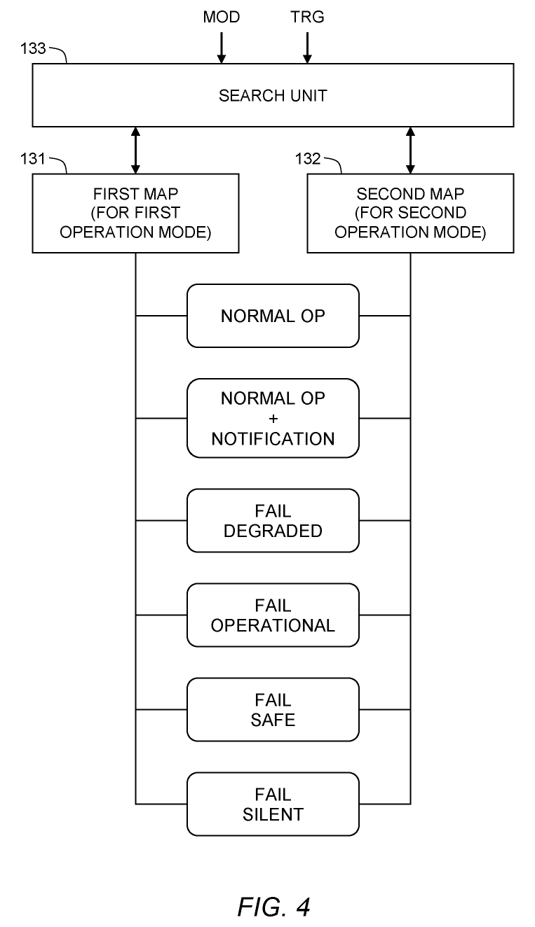

FIG. 4 is a conceptual diagram for explaining an example of the control state determination unit 130. The control state determination unit 130 includes a first map 131, a second map 132, and a search unit 133.

The first map 131 and the second map 132 both are maps that define a correspondence relationship between the content of the trigger and the automated driving control state. In other words, the first map 131 and the second map 132 both are maps that define the automated driving control state for each trigger. The first map 131 is selectively used in the case of the first operation mode (i.e., the first level). On the other hand, the second map 132 is selectively used in the case of the second operation mode (i.e., the second level). The first map 131 and the second map 132 are generated in advance and stored in the storage device 102.

The following are examples of the types of the automated driving control state.

Normal state (Normal Operation): the automated driving control is performed as usual without limiting a function or performance.

Fail degraded state (Fail Degraded): the automated driving control is continued while limiting a function or performance.

Fail operational state (Fail Operational): the automated driving control is executed in a safe state by using the redundant system.

Fail safe state (Fail Safe): the automated driving control is terminated in a safe state.

Fail silent state (Fail Silent): an output from the automated driving control is stopped.

The search unit 133 receives the operation mode information MOD and the trigger information TRG. The search unit 133 selects a map corresponding to the current operation mode indicated by the operation mode information MOD. Specifically, when the current operation mode is the first operation mode, the search unit 133 selects the first map 131. On the other hand, when the current operation mode is the second operation mode, the search unit 133 selects the second map 132. Then, the search unit 133 refers to the selected map to acquire the automated driving control state associated with the trigger.

### 4-2. Various Examples

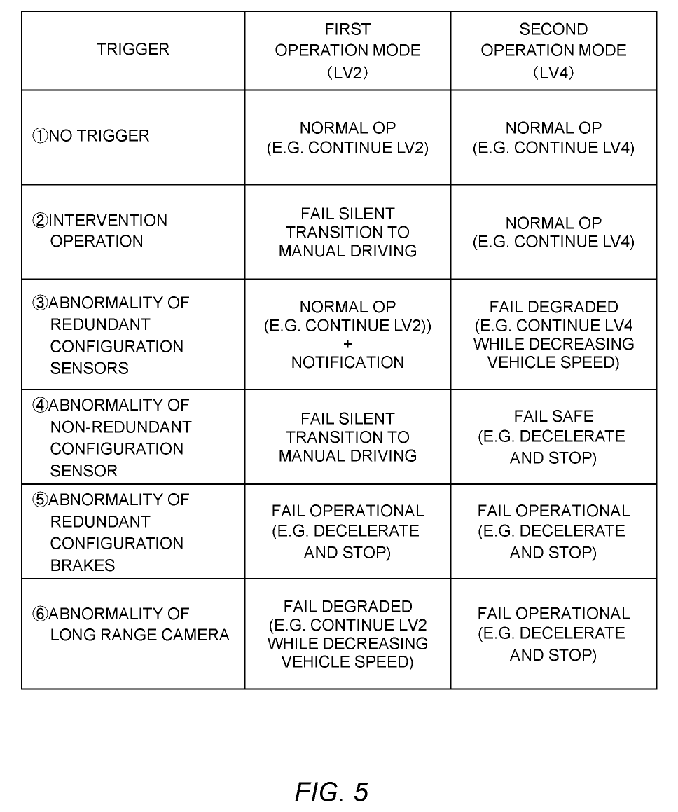

FIG. 5 shows various examples of setting of the automated driving control state in consideration of the content of the trigger and the current operation mode.

### 4-2-1. First Example

When no trigger is input, the control device 100 continues the automated driving control in the normal state.

### 4-2-2. Second Example

In a second example, the trigger is an intervention operation performed by the operator. The setting of the automated driving control state in this case is as follows.

When the current operation mode is the first operation mode, the control device 100 requests the operator to transition to manual driving, and sets the automated driving control state to the fail silent state. Due to the transition to the manual driving, the vehicle operation in the first operation mode continues. That is, the continuity of the vehicle operation is ensured.

When the current operation mode is the second operation mode, the control device 100 does not receive the intervention operation performed by the operator and continues the automated driving control in the normal state. This ensures not only the continuity of the automated driving control but also the continuity of the vehicle operation.

### 4-2-3. Third Example

In a third example, the sensors having a redundant configuration is considered. The redundant configuration sensors are configured by a main system and a sub system. The trigger is detection of an abnormality of one of the main system and the sub system of the redundant configuration sensors. The setting of the automated driving control state in this case is as follows.

When the current operation mode is the first operation mode, the control device 100 maintains the automated driving control state in the normal state. That is, the control device 100 continues the automated driving control of the first level without limiting the function or performance. Since the other of the redundant configuration sensors is normal and the operator is also present, it is not necessary to immediately terminate the automated driving control, and it is possible to safely continue the automated driving control. This ensures continuity of the automated driving control and continuity of the vehicle operation. However, the control device 100 may notify the operator of the occurrence of the abnormality in the redundant configuration sensors through the HMI 50. This notification enables the operator to consider a countermeasure such as performing an intervention operation and the like.

When the current operation mode is the second operation mode, the control device 100 sets the automated driving control state to the fail degraded state (Fail Degraded). That is, the control device 100 continues the automated driving control of the second level while limiting the function or performance. For example, the control device 100 continues the automated driving control of the second level by decreasing an upper limit value of the vehicle speed to be lower than the default value. Since the other of the redundant configuration sensors is normal, it is not necessary to immediately terminate the automated driving control, and it is possible to safely continue the automated driving control. This ensures continuity of the automated driving control and continuity of the vehicle operation.

### 4-2-4. Fourth Example

In a fourth example, a non-redundant configuration sensor that does not have a redundant configuration is considered. The trigger is detection of an abnormality of the non-redundant configuration sensor. The setting of the automated driving control state in this case is as follows.

When the current operation mode is the first operation mode, the control device 100 requests the operator to transition to the manual driving, and sets the automated driving control state to the fail silent state (Fail Silent). The vehicle operation in the first operation mode continues due to the transition to the manual driving. That is, the continuity of the vehicle operation is ensured.

When the current operation mode is the second operation mode, the control device 100 sets the automated driving control state to the fail safe state (Fail Safe). For example, the control device 100 performs the automated driving control so as to decelerate and stop the vehicle 1.

### 4-2-5. Fifth Example

In a fifth example, a brake having a redundant configuration is considered. The redundant configuration brakes are configured by a main system and a sub system. The trigger is detection of an abnormality of one of the main system and the sub system of the redundant configuration brakes. The setting of the automated driving control state in this case is as follows.

When the current operation mode is the first operation mode, the control device 100 sets the automated driving control state to the fail operational state (Fail Operational). For example, the control device 100 performs the automated driving control so as to decelerate and stop the vehicle 1 by using the other (i.e., normal one) of the main system and the sub system of the redundant configuration brakes.

The same applies to a case where the current operation mode is the second operation mode. The control device 100 sets the automated driving control state to the fail operational state. For example, the control device 100 performs the automated driving control so as to decelerate and stop the vehicle 1 using the other (i.e., normal one) of the main system and the sub system of the redundant configuration brakes.

### 4-2-6. Sixth Example

In a sixth example, a plurality of cameras are considered. A first camera is used to recognize a relatively near object. A second camera is a long range camera that captures an image of a farther area than the first camera, and is used to recognize a relatively far object. During high-speed traveling, it is desirable to use both the first camera and the second camera. In a sixth example, the trigger is detection of an abnormality of the second camera. It is assumed that the first camera is normal. The setting of the automated driving control state in this case is as follows.

When the current operation mode is the first operation mode, the control device 100 sets the automated driving control state to the fail degraded state (Fail Degraded). That is, the control device 100 continues the automated driving control of the first level while limiting the function or performance. For example, the control device 100 continues the automated driving control of the first level by decreasing the upper limit value of the vehicle speed to be lower than the default value. Since the first camera is normal and the operator is also present, it is not necessary to immediately terminate the automated driving control, and it is possible to safely continue the automated driving control. This ensures continuity of the automated driving control and continuity of the vehicle operation.

When the current operation mode is the second operation mode, the control device 100 sets the automated driving control state to the fail operational state. For example, the control device 100 performs the automated driving control so as to decelerate and stop the vehicle 1 while performing the recognition process using the normal first camera.

### 4-3. Processing Flow

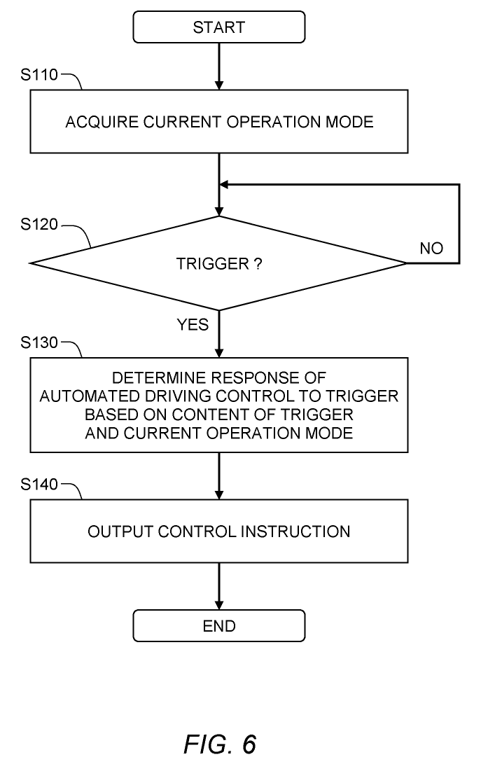

FIG. 6 is a flowchart summarizing the processing related to the determination of the automated driving control state according to the present embodiment.

In Step S110, the control device 100 acquires the operation mode information MOD indicating the current operation mode. The control device 100 stores the operation mode information MOD in the storage device 102.

In Step S120, the control device 100 determines whether or not the trigger information TRG is received. When the trigger information TRG is received (Step S120; Yes), the processing proceeds to Step S130.

In Step S130, the control device 100 determines an appropriate automated driving control state based on the content of the trigger and the current operation mode (i.e., the current automated driving level). That is, the control device 100 determines the response of the automated driving control to the trigger based on both the content of the trigger and the current operation mode (i.e., current automated driving level). The control device 100 stores information on the determined automated driving control state in the storage device 102.

In Step S140, the control device 100 determines the control instruction amount of the travel device 40 according to the determined automated driving control state, and controls the travel device 40.

What is claimed is:

1. A vehicle control system for controlling a vehicle,
the vehicle control system comprising processing circuitry configured to execute automated driving control by switching between a plurality of automated driving levels, wherein
the plurality of automated driving levels include:
a first level that requires a human operation or human monitoring as needed; and
a second level that does not require a driving operation by a human, and
the processing circuitry is further configured to:
acquire, during execution of the automated driving control, abnormality detection information indicating detection of an abnormality of a component of the vehicle used for the automated driving control; and
determine a response of the automated driving control to the abnormality, based on both a content of the abnormality and a current automated driving level.

2. The vehicle control system according to claim 1, wherein
the component includes redundant configuration sensors,
when the abnormality is an abnormality of one of the redundant configuration sensors and the current automated driving level is the first level, the processing circuitry continues the automated driving control without limiting a function or performance, and
when the abnormality is an abnormality of one of the redundant configuration sensors and the current automated driving level is the second level, the processing circuitry continues the automated driving control while limiting a function or performance.

3. The vehicle control system according to claim 1, wherein
the component includes a non-redundant configuration sensor,
when the abnormality is an abnormality of the non-redundant configuration sensor and the current automated driving level is the first level, the processing circuitry requests an operator of the vehicle to transition to manual driving and sets a state of the automated driving control to a fail silent state, and
when the abnormality is an abnormality of the non-redundant configuration sensor and the current automated driving level is the second level, the processing circuitry sets the state of the automated driving control to a fail safe state.

4. The vehicle control system according to claim 1, wherein
the component includes redundant configuration brakes;
when the abnormality is an abnormality of one of the redundant configuration brakes and the current automated driving level is the first level, the processing circuitry performs the automated driving control to decelerate the vehicle using another of the redundant configuration brakes, and
when the abnormality is an abnormality of one of the redundant configuration brakes and the current automated driving level is the second level, the processing circuitry performs the automated driving control to decelerate the vehicle using another of the redundant configuration brakes.

5. The vehicle control system according to claim 1, wherein
the component includes a first camera and a second camera that captures an image of a farther area than the first camera,
when the abnormality is an abnormality of the second camera and the current automated driving level is the first level, the processing circuitry continues the automated driving control while limiting a function or performance, and
when the abnormality is an abnormality of the second camera and the current automated driving level is the second level, the processing circuitry performs the automated driving control to decelerate the vehicle.
